(19) United States
(12) Patent Application Publication
(10) Pub. No.: US 2009/0115960 A1
(43) Pub. Date: May 7, 2009

(54) LENS ATTACHMENT COMBINED WITH FORMATION OF FLEXIBLE EYEWEAR FRAME

(76) Inventor: Brent SHELDON, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/933,472

(22) Filed: Nov. 1, 2007

(51) Int. Cl. G02C 13/00; B29D 12/02

(52) U.S. Cl. 351/140; 351/178

(57) ABSTRACT

The present invention provides a method and structural arrangement for permanently attaching lenses to eyewear having a relatively flexible frame body made of a relatively soft material. The attachment of the lenses to the frame structures of eyewear is achieved during the formation of the relatively flexible frame body. A variety of engaging structures between the lenses and the relatively flexible frame body can be formed together with the formation of the relatively flexible frame body during a molding procedure.

### FIELD OF THE INVENTION

The present invention relates to eyewear, and more particularly to a method and a structural arrangement for attaching lenses to flexible frames of eyewear.

### BACKGROUND OF THE INVENTION

Conventional eyewear generally includes eye glasses and goggles, the frames of which are usually made of substantially rigid plastics, relatively soft and flexible plastics or other elastomer materials. There has been a problem of securely attaching lenses to eyewear frames. Conventionally, frames of eyewear typically define one or a pair of apertures for receiving lenses therein, respectively. Such lenses are usually made of glass or rigid transparent plastics, which have limited resiliency properties. The lenses are attached to the respective apertures of the frame of eyewear using a “click in” action which forces elastic deformation of either or both the lenses and a portion of the frame body defining the respective apertures when each lens is pressed into one of the apertures. However, neither the rigid lens nor the portion of the rigid frame body defining the aperture provides a significant elastic deformation during the “click in” action for a more secure attachment of the lens to the frame. In the case of frames made of a relatively soft material, the relatively easy elastic deformation of the frame may not ensure a secure attachment of the lenses. Eyewear users unfortunately sometimes suffer the loss of lenses from their eyewear because the lenses have become less firmly retained within the apertures of the frame over a period of usage. It should be noted, that the conventional “click in” type of attachment of lenses to the apertures of the eyewear frames requires a relatively accurate geometry of both the peripheries of lenses and the apertures of the frames, when the lenses and frames are fabricated in separate manufacturing processes. The conventional “click in” type of attachment is also not applicable for frames which do not defines lens apertures.

Therefore, there is a need for a secure attachment of lenses to frames of eyewear, particularly to relatively flexible frames of eyewear.

### SUMMARY OF THE INVENTION

In accordance with one aspect of the present invention, there is a method provided for attaching a substantially rigid lens to a flexible eyewear frame of a soft material. The method comprises steps of providing a molding device for molding the flexible eyewear frame; placing the lens in a predetermined position with respect to the molding device, in the predetermined position a portion of the molding device overlapping a portion of the lens; and forming the flexible eyewear frame with permanent engagement of the lens thereto using the molding device.

In accordance with another aspect of the present invention there is a structural arrangement for attaching a lens to a frame of eyewear. The structural arrangement comprises a flexible frame body made of a soft material. A plurality of retaining members are integrally formed together with the flexible frame body. The respective retaining members are contoured to achieve permanent attachment of the lens to the flexible frame body during formation of the flexible frame body.

The method and structural arrangement of the present invention provides a permanent attachment of lenses to the flexible frames of eyewear, which eliminates the possibility of losing lenses from the eyewear.

Other features and advantages of the present invention will be better understood with reference to the preferred embodiments described hereinafter.

### DESCRIPTION OF THE DRAWINGS

Having thus generally described the nature of the present invention, reference will now be made to the accompanying drawings, showing by way of illustration the preferred embodiments thereof, in which:

FIG. 1 is a perspective view of eyewear having a flexible frame permitting ventilation, configured for permanent attachment of a lens to a flexible frame structure in accordance with one embodiment of the present invention;

FIG. 2A is a front elevational view of the eyewear of FIG. 1, showing retaining members integrally formed with the relatively flexible frame body;

FIG. 2B is a partial cross-sectional view of the eyewear of FIG. 2A, taken along line 2-2, showing a structural arrangement of this embodiment;

FIG. 2C is a partial cross-sectional view similar to the view of FIG. 2B, showing a formation molding procedure of the relatively flexible frame body with permanent attachment of the lens thereto;

FIG. 2D is a cross-sectional view of the eyewear of FIG. 2A, taken along 2-2 showing an alternative structural arrangement of this embodiment;

FIG. 2E is a partial cross-sectional view of the eyewear of FIG. 2A, taken along line 2-2 showing a further alternative structural arrangement thereof;

FIG. 3A is a front elevational view of eyewear having a flexible frame permitting ventilation, configured for permanent attachment of a lens to the flexible frame structure thereof according to another embodiment of the present invention;

FIG. 3B is a partial cross-sectional view of the eyewear of FIG. 3A, taken along line 3-3, showing a structural arrangement thereof;

FIG. 3C is a partial cross-sectional view of the eyewear of FIG. 3A, taken along line 3-3, showing an alternative structural arrangement thereof;

FIG. 4A is a front elevational view of eyewear having a flexible frame permitting ventilation, configured for permanent attachment of a lens to the flexible frame structure thereof in accordance with a further embodiment of the present invention;

FIG. 4B is a partial cross-sectional view of the eyewear of FIG. 4A, taken along line 4-4, showing a structural arrangement thereof;

FIG. 4C is a partial cross-sectional view similar to that of FIG. 4B, showing an alternative structural arrangement thereof;

FIG. 5A is a perspective view of eyewear having a flexible frame permitting ventilation, configured for permanent attachment of a pair of lenses to the flexible frame structure thereof in accordance with a still further embodiment of the present invention;

FIG. 5B is a partial cross-sectional view of the eyewear of FIG. 5A, taken along line 5-5, showing a structural arrangement thereof;

FIG. 5C is a partial cross-sectional view of the lens shown in FIG. 5B, showing a hollow space defined therein;

FIG. 5D is a front elevational view of the lens shown in FIG. 5B showing the hollow space defined therein; and

FIG. 5E is a partial cross-sectional view of the eyewear of FIG. 5A, taken along line 5-5, showing a structural arrangement thereof, alternative to that of FIG. 5B.

### DETAILED DESCRIPTION OF THE PREFERRED EMBODIMENTS

It should be noted that the term “eyewear having a flexible frame permitting ventilation” used throughout the entire specification and appended claims includes a variety of eyewear such as sunglasses, ski goggles, etc., which allow for air ventilation and require neither fluid-tight attachment of lenses to the frames thereof, nor fluid-tight seals around the eyes of users, and therefore, exclude swimming goggles, diving goggles, and the like.

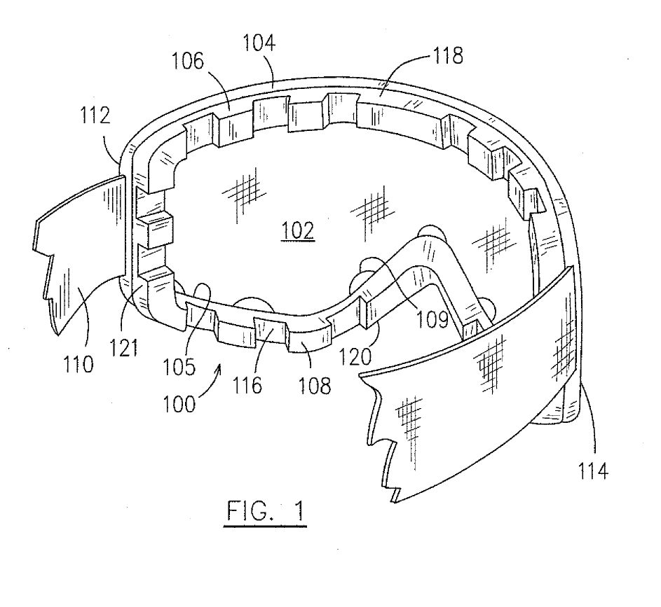

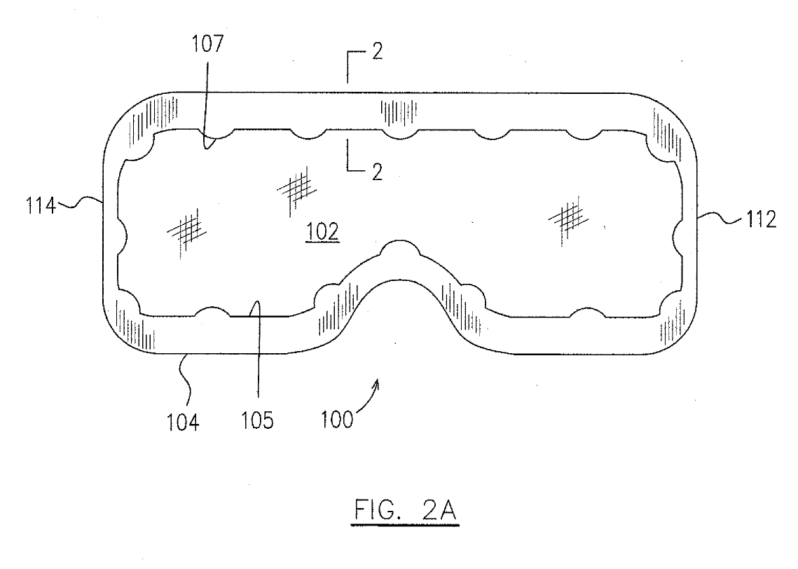

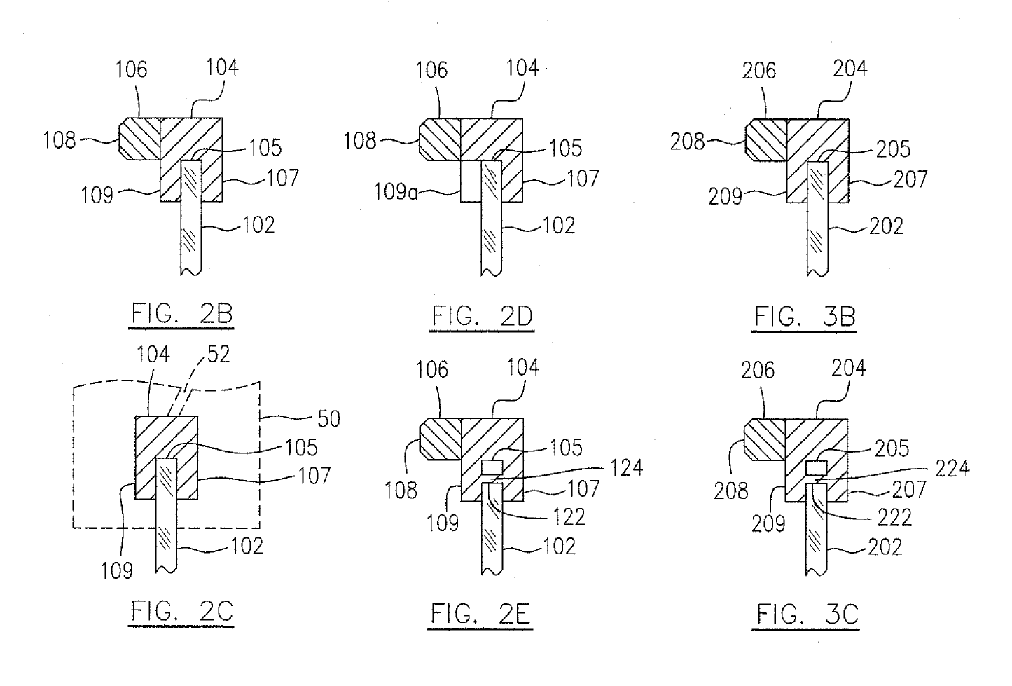

FIGS. 1 and 2A-2E illustrate eyewear having a flexible frame permitting ventilation such as protective goggles, indicated by numeral 100, in accordance with a first embodiment of the present invention. The eyewear 100 is used as an example to illustrate one embodiment of the present invention. Nevertheless, any other type of eyewear which includes relatively flexible frame bodies and substantially rigid lenses, and which permits ventilation in various ways, is included in the concept of the present invention as illustrated by the embodiment 100 and in further embodiments to be described hereinafter.

The eyewear 100 includes a single lens 102 which is made of glass or substantially rigid transparent plastic, a relatively flexible frame body 104 defining an aperture 105 receiving the single lens 102 therein, and a shielding member 106 contoured for shielding the eyes of a user. The relatively flexible frame body 104 is made of a relatively soft material and such as soft plastics, rubber, other elastomers, etc., and includes a plurality of retaining members 107 and 109 for securing the lens 102. The shielding member 106 which is made of a soft material such as rubber in this embodiment, is attached to the inner side of the relatively flexible frame body 104 and has a contacting surface 108 The shielding member 106 may also be an integral part of the relatively flexible frame body 104. The combination of the single lens 102, the relatively flexible frame body 104 and the shielding member 106, is contoured such that the contacting surface 108 of the shielding member 106 contacts the face of the user (not shown) in a comfortable manner and the shielding member thereby forms a substantial enclosure between the single lens 102 and the face of the user when the eyewear 100 is worn.

An elastic strap 110 is attached to opposite sides 112, 114 of the relatively flexible frame body 104 for holding the eyewear 100 on the head of the user by a means well known in the art which will therefore not be described herein.

A plurality of ventilation channels 116 are formed on the contacting surface of the shielding member 106 in the top section 118 and bottom section 120 as well as side sections 121, such that air circulation through the enclosure defined between the single lens 102 and the face of the user eliminate condensation on the single lens 102.

The retaining members 107 which are referred as the retaining members of a first group hereinafter, are integrally formed together with the relatively flexible frame body 104 and extend into the aperture 105. The retaining members 109 which are referred to as retaining members of a second group hereinafter, are also integrally formed together with the relatively flexible frame body 104 and extend into the aperture 105. The second group of retaining members 109 is spaced apart from the first group of retaining members 107, and the first and second groups of retraining members 107, 109 abut the respective opposed front and rear sides of the single lens 102, thereby engaging a plurality of peripheral parts of the single lens 102 therebetween. The number and size of the first and second groups of the retaining members 107, 109 may be identical and may be disposed to correspond one with another in the circumferential direction of the aperture 105, as shown in FIG. 2B, but this is optional rather than necessary. The first and second groups of the retaining members 107, 109 must have a dimension thereof which is much greater than the total allowed maximum elastic deformation of the single lens 102 and the relatively flexible frame body 104, in order to prevent disengagement of the single lens 102 from the first and second groups of the retaining members 107, 109, thereby ensuring permanent attachment of the single lens 102 within the aperture 105.

In FIG. 2C there is an illustration of a flexible frame body formation molding procedure together with the attachment of the single lens 102 to the relatively flexible frame body 104. A molding device 50 is indicated with a broken line representing a partial section thereof. The molding device 50 defines a cavity (not indicated) in accordance with a configuration of the relatively flexible frame body 104 and the first and second groups of the retaining members 107, 109, and includes a molding injection passage 52 communicating with this cavity in order to permit injection of a relatively soft molding material in an appropriate state, into the cavity during a formation molding procedure.

The single lens 102 is placed in a predetermined position with respect to the molding device 50 such that at least a portion of the molding device overlaps a portion of the single lens 102, and the single lens 102 closes major openings of the cavity of the molding device 50 except for the molding injection passage 52 and air escape passages (not shown). When the single lens 102 is placed and held by tools (not shown) in this predetermined position and closes the major openings of the cavity of the molding device 50, the formation molding procedure begins and the cavity is filled with the molding material, thereby forming the relatively flexible frame body 104 which defines the aperture 105 therein, with permanent attachment of the lens thereto.

The shielding member 106 is then attached to the inner side of the relatively flexible frame body 104 by any well known means, such as glue. However, if the shielding member 106 is preferred to be an integral part of the relatively flexible frame body 104, it can be formed together with the relatively flexible frame body 104 during the formation of the latter, provided that the molding device 50 is provided with an appropriate cavity therein.

FIG. 2D illustrates an alternative structural arrangement of the embodiment shown in FIG. 2A. In this alternative structural arrangement, the second group of retaining members which are indicated by 109a to be distinguished from the second group of retaining members 109 of FIG. 2B, are positioned to be not aligned with the first group of retaining members 107, respectively. The first and second groups of the retaining members 107, 109a are offset in the circumferential direction, which does not affect the permanent engagement of the single lens 102 within the relatively flexible frame body 104, provided that the dimension of the first and second groups of retaining members 107, 109a of the structural arrangement of FIG. 2D is not smaller than the dimension of the first and second groups of the retaining members 107, 109 of the structural arrangement of FIG. 2B.

A further alternative structural arrangement of the eyewear 100 of FIG. 2A is illustrated in FIG. 2E. The single lens 102 is provided with a hollow space defined therein, for example, a plurality of holes 122 extending through the single lens 102. The holes 122 are disposed in the respective peripheral parts of the single lens 102 corresponding to the respective positions of the aligned first and second groups of the retaining members 107, 109. During the formation molding procedure of the relatively flexible frame body 104, similar to that illustrated in FIG. 2C, a portion of the relatively soft molding material which is in an appropriate state to form the relatively flexible frame body 104 is filled into the respective holes 122 defined through the single lens 102, thereby forming a plurality of studs 124 integrated with the relatively flexible frame body 104. Each of the studs 124 extends between one of the first group of retaining members 107 and one of the second group of retaining members 109 through one of the holes 122. These studs 124 reinforce the permanent attachment of the single lens 102 to the relatively flexible frame body 104.

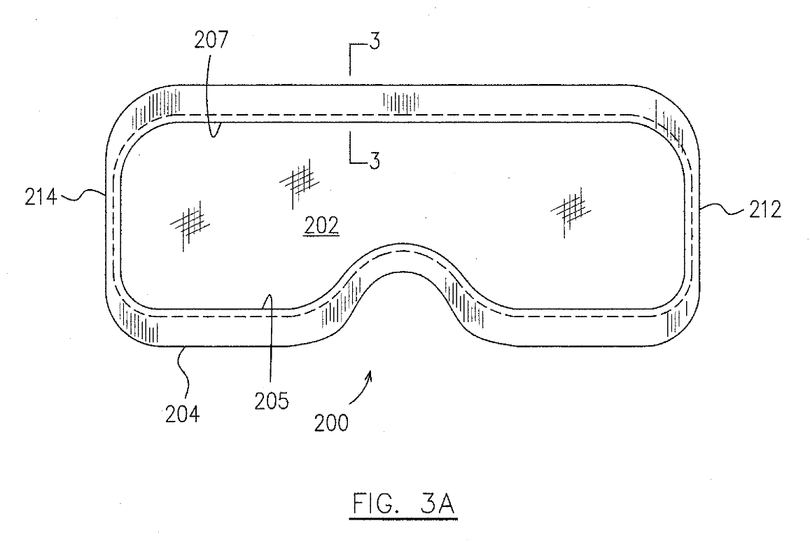

FIGS. 3A-3C illustrate another embodiment of the present invention in which eyewear 200 having a flexible frame permitting ventilation is similar to the eyewear 100 of FIGS. 2 and 2A. The components of eyewear 200 are indicated using numerals in the 200 series with the last two digits corresponding to similar components in the 100 series illustrated in FIGS. 2 and 2A, and will not therefore be redundantly described. The embodiment shown in FIG. 3A is a further development of the embodiment shown in FIGS. 2 and 2A. When the retaining members 107 and 109 of the eyewear 100 (as shown in FIGS. 2A and 2B), are connected adjacent to one another in each of the first and second groups, these retaining members substantially form opposed continuous side walls 207, 209 extending into an aperture 205 of the eyewear 200, thereby defining a continuous channel therebetween (not indicated). The continuous channel defined between opposed side walls 207, 209 is configured to correspond to the periphery of a single lens 202 for receiving the periphery of the single lens 202, and has a depth which is much greater than the amount of total maximum elastic deformation of the single lens 202 and a relatively flexible frame body 204, in order to permanently engage the single lens 202 when the attachment of the single lens 202 to the aperture 205 is completed during the formation of the relatively flexible frame body 204.

The formation of the relatively flexible frame body 204 is completed in a molding process using a molding device (not shown) similar to the molding device 50 of FIG. 2C with a cavity defined therein corresponding to the configuration of the relatively flexible frame body 204, and particularly to the configuration of the opposed continuous side walls 207, 209. The single lens 202 is placed in a predetermined position with respect to the molding device. A continuous portion of the molding device overlaps a continuous periphery portion of the single lens 202 at both sides thereof (the cross-section will be similar to that illustrated in FIG. 2C) such that the relatively flexible frame body 204 is formed with the opposed continuous walls 207, 209 extending therefrom into the aperture 205.

It should be noted that in this embodiment and other embodiments to be further described, the molding devices are similar to the molding device 50 with different cavities defined therein. In order to focus on the structural features of each embodiment of the present invention and avoid redundant illustration, the other molding devices will not be shown and the description of the corresponding formation molding procedures will be referred to the molding device 50 of FIG. 2C.

FIG. 3C illustrates an alternative structural arrangement for the permanent attachment of the single lens 202 to the aperture 205 of the eyewear 200. In this alternative structural arrangement, the single lens 202 is provided with a hollow space therein, for example, a plurality of holes 222 extending through a peripheral portion of the single lens 202. During the molding procedure of the relatively flexible frame body 204, the peripheral portion of the lens defining the holes 222 therein, overlaps a portion of a molding device similar to the molding device 50 of FIG. 2C such that a portion of the relatively flexible frame body 204 is filled into the hollow space of the single lens 202, thereby forming a plurality of studs 224 integrated with the relatively flexible frame body 204 and extending between the side walls 207 and 209 through the holes 222. The holes 222 are spaced apart from one another along the periphery of the single lens 202, and thus the studs 224 extending therethrough reinforce the permanent attachment of the single lens 202 to the aperture 205 defined in the relatively flexible frame body 204.

It should be noted that the side walls 207 and 209 in the structural arrangement shown either in FIG. 3B or 3C, may not necessarily be continuous along the circumferential direction, circling the aperture 205. For example, upper and lower sections of the opposed side walls 207 and 209 are sufficient to secure the single lens 202.

The attachment of the lens to the apertures of the frame structure of eyewear according to the present invention is achieved by permanent engagement resulting from specific structural arrangements between the lens and the relatively flexible frame body, rather than frictional forces therebetween resulting from elastic deformation of both lens and frame body as in the prior art. Thus, the attachment of the lens to the frame structure according to the present invention is much more secure and completely eliminates the risk of losing the lens. Furthermore, the structural arrangement for the permanent engagement of a lens according to the present invention requires less accurate peripheral geometry of the lens because the attachment of the lens to the aperture of the frame bodies is achieved during the formation of the frame bodies, which results in an automatic match between the periphery of the lens and the inner periphery of the relatively flexible frame body defining the aperture.

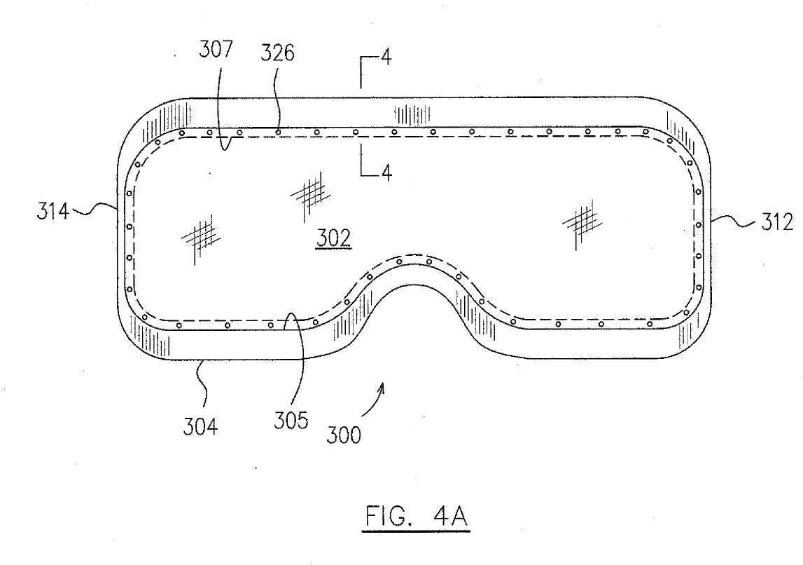

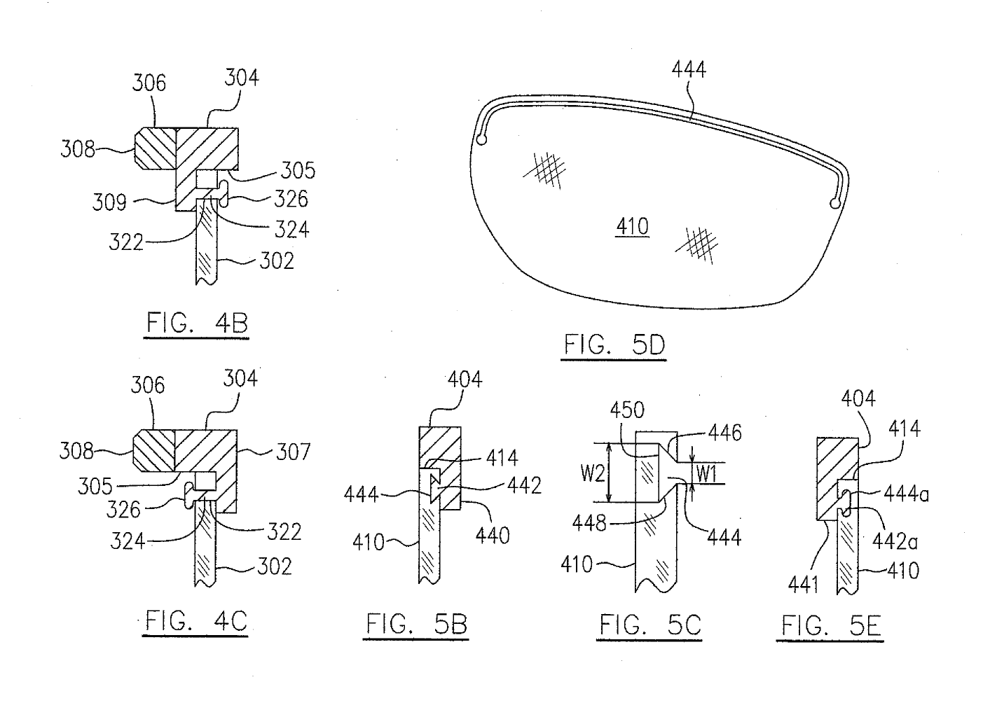

FIGS. 4A-4C illustrate a further embodiment of the present invention generally indicated by numeral 300. The embodiment 300 is eyewear having a relatively flexible frame permitting ventilation, including components similar to those of the eyewear 100 shown in FIGS. 1 and 2A-2E. These similar components are indicated by numerals in the 300 series with the last two digits similar to those corresponding components of the eyewear 100 of FIGS. 1 and 2A-2E, and will not therefore be redundantly described. Instead of having the plurality of retaining members 107, 109 of FIG. 2B, the eyewear 300 includes a structural arrangement in which a single lens 302 is provided with a hollow space defined as a plurality of holes 322 extending through the single lens 302. The holes 322 are spaced apart one from another: and are defined in a peripheral portion of the single lens 302. The peripheral portion of the single lens 302 defining the holes 322 therein abuts a continuous rear side wall 309 extending from a relatively flexible frame body 304 into an aperture 305, defined within the relatively flexible frame body 304. A plurality of studs 324 formed integrally with the relatively flexible frame body 304, are filled into the respective holes 322. Furthermore, the studs 324 extend from the continuous rear side wall 309 through the respective holes 322. Each stud 324 terminates at an enlarged end 326 thereof which has a size greater than the diameter of the stud. Thus the studs 324 permanently engage the single lens 302 in the aperture 305 between the continuous rear side wall 309 and the enlarged end 326 of the studs 324. This structural arrangement is also achieved during the formation of the relatively flexible frame body 304 in a molding procedure similar to that illustrated in FIG. 2C. An appropriate cavity configuration should be provided in the molding device in order to mold the relatively flexible frame body 304 such that when the single lens 302 is placed in the predetermined position in which the single lens 302 overlaps a portion of the molding tool and closes major openings of the cavity, the molding plastic material will fill the cavity, thereby forming the relatively flexible frame body 304 and the studs 324 with their enlarged ends 326 with the attachment of the single lens 302 thereto.

In an alternative arrangement illustrated in FIG. 4C, a continuous side wall can be disposed in the front of the eyewear 300 such that the continuous rear side wall 309 of FIG. 4B becomes a continuous front side wall 307 of FIG. 4C, and the plurality of enlarged ends 326 of the studs 324 are disposed behind the single lens 302, resulting in the front view of the eyewear 300 appearing similar to the eyewear 200 illustrated in FIG. 3A.

Depending on the softness of the material of which the relatively flexible frame body 304 is made, the enlarged ends 326 of the studs 324 have a size sufficient to overcome the elastic deformation of the enlarged ends 326 in order to ensure the permanent engagement the lens 302.

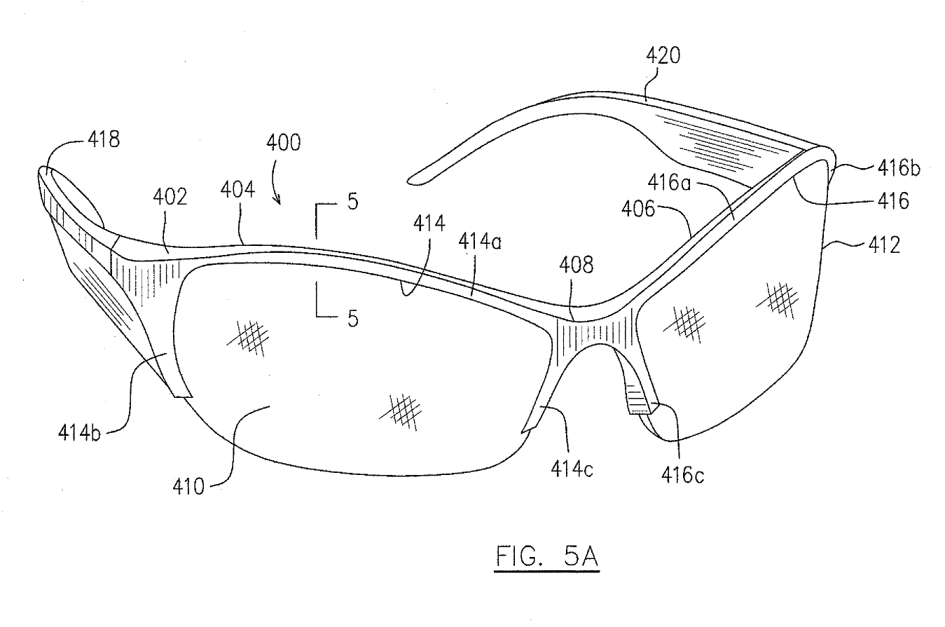

FIGS. 5A-5E illustrate a still further embodiment of the present invention, generally designated by reference numeral 400, which includes a frame structure 402 having two relatively flexible frame bodies 404, 406 integrated together, with a bridge 408 connected between an inner side of the frame bodies 404, 406, and also includes a pair of substantially rigid lenses 410 and 412 received and affixed in recesses 414 and 416 which are defined in the respective relatively flexible frame bodies 404, 406. The attachment of the lenses 410, 412 to the respective frame bodies 404, 406 will be further described hereinafter. A pair of temples 418 and 420 are pivotally mounted to opposed sides of the frame structure 402 by means of a hinge assembly (not shown) which is well known in the art and will not be described herein. Each of the relatively flexible frame bodies 404, 406 has an upper portion 414a or 416a and opposed side portions 414b and 414c or 416b and 416c which extend downwardly from the upper portion 414a or 416a. The upper portion 414a or 416a in combination with the side portions 414b and 414c or 416b and 415c forms the recess 414 or 416.

The frame structure 402 including the relatively flexible frame bodies 404, 406 and the bridge 408 therebetween are preferably made of a relatively soft material The lenses 410 and 412 are made of glass or substantially rigid transparent plastic material. The pivotally attached temples 418, 420 may be made of a material different from that of and thus are more rigid than the relatively flexible frame bodies 404, 406.

Although there are no dedicated air venting passages, eyewear 400, representing such eyewear as sunglasses, etc., does permit ventilation through the space between the frame structure and the user's face when eyewear 400 is in use, because eyewear 400 does not include any shielding members for comfortably contacting a portion of the user's face around the eye.

The eyewear 400 is symmetrical about its central axis (not shown) and the left and right halves are identical. Therefore the description of a structural arrangement and method for permanent attachment of the lenses to the frame structure of the eyewear will be simplified by making reference to only one lens attachment to the one relatively flexible frame body of the frame structure of the eyewear in this embodiment.

In order to attach the lens 410 in the recess 414 defined in the relatively flexible frame body 404, the relatively flexible frame body 404 includes a front side wall 440 extending from the upper portion 414a and side portions 414b, 414c into the recess 414 and contacting the peripheral portion on the front side of the lens 410. A projecting member 442 is formed integrally with the front side wall 440 and is filled into a hollow space defined in the peripheral portion on the front side of the lens 410. The hollow space defined in the lens 410 is a groove 444 extending substantially along an upper peripheral portion of the lens 410. The groove 444 includes opposed side walls 446, 448 and a bottom 450. A distance W1 defined between the opposed walls 446, 448 at the opening (not indicated) of the groove 444 must be smaller than a distance W2 defined between the opposed walls 446, 448 at the bottom 450 of the groove 444. The projecting member 442 filled into the groove 444 during a formation molding procedure of the frame formation, is configured in accordance with the cross-section of the groove 444, thereby permanently engaging the lens 410 in the recess 414 defined in the relatively flexible frame body 404.

In order to cut the grove 444 in the lens 410 having W1 smaller than W2, the opening size W1 may be enlarged at one or both ends of the groove 444, for inserting and withdrawing a cutter, thereby forming an enlarged recess at one or both ends of the groove as shown in FIG. 5D.

FIG. 5E illustrates a structural arrangement alternative to that shown in FIG. 5B. The difference between the structural arrangements of FIGS. 5 and 5E is that instead of having the front side wall 440 of FIG. 5B, the relatively flexible frame body 404 of FIG. 5E includes a rear side wall 441 extending into the recess 414 and contacting the peripheral portion on the rear side of the lens 410. A projecting member 442a is formed integrally with the rear side wall 441 and is filled into a hollow space defined in the peripheral portion on the rear side of the lens 410. The hollow space defined in the lens 410 is one or several grooves 444a which extend along the upper peripheral portion of the lens 410. The groove 444a has a cross-section which may be similar to the cross-section of the groove 444 as shown in FIG. 5C or may be configured differently, provided that the distance W1 is smaller than the distance W2. For example, a T-shaped cross-section of the groove 444a is illustrated as an alternative example.

The formation of the relatively flexible frame bodies 404, 406 with attachment of the respective lenses 410, 412 thereto, is a molding procedure using a molding device (not shown) similar to that described in FIG. 2C, and will not be repeated herein. Nevertherless, each eyewear 400 includes a pair of relatively flexible frame bodies 404, 406 and a bridge 408 interconnecting same. Therefore, the molding device used to form the frame structure 402 should have a cavity accordingly and thereby form the pair of relatively flexible frame bodies 404, 406 and the bridge 408 simultaneously with permanent attachment of the lenses 410, 412 thereto.

It should be noted that other structural arrangements such as those illustrated in FIGS. 2E, 3C, 4B and 4C are also applicable to the eyewear illustrated in FIGS. 5A-5E. Alternatively, the structural arrangements illustrated in FIGS. 5A-5E are also applicable to eyewear illustrated in FIG. 4.

The variety of structural arrangements of the present invention also advantageously provide a selection of styling options for eyewear. For example, the embodiments illustrated in FIGS. 2A and 4A present novel styling features which cannot be achieved by conventional eyewear using a “click-in” attachment.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

I/we claim:

1. A method for permanently attaching a substantially rigid lens to a flexible eyewear frame of a soft material, the method comprising steps of:
providing a molding device for molding the flexible eyewear frame;
placing the lens in a predetermined position with respect to the molding device, in which position a portion of the molding device overlaps a portion of the lens; and
forming the flexible eyewear frame with permanent engagement of the lens thereto, using the molding device.

2. The method as claimed in claim 1 further comprising a step of introducing the soft material in a flowable molding state into the molding device during the molding process.

3. The method as claimed in claim 2 further comprising a step of providing a hollow space defined in a portion of the lens to be attached such that a portion of the flexible eyewear frame is filled into the hollow space defined in the lens during the frame forming step, thereby permanently engaging the lens.

4. The method as claimed in claim 3 wherein the hollow space in the lens is defined as a plurality of holes extending through said portion thereof which is overlapped by said portion of the molding device such that a plurality of studs formed together with the flexible eyewear frame in the forming step extend through the individual holes in each lens to permanently engage each lens to the flexible eyewear frame.

5. The method as claimed in claim 3 wherein the hollow space in the lens is defined as a groove formed in said portion thereof which is overlapped by said portion of the molding device, a distance between opposed walls of the groove at an opening thereof being smaller than a distance between the opposed walls at a bottom of the groove such that a projecting member formed together with the flexible eyewear frame in the forming step is filled into the groove in each lens to permanently engage the lens to the substantially rigid plastic frame.

6. The method as claimed in claim 2 wherein a continuous portion of the molding device overlaps a continuous peripheral portion of the lens at both sides thereof such that the flexible eyewear frame is formed with opposed continuous walls, thereby defining a continuous channel between the opposed continuous walls configured to correspond to the peripheral portion of the lens, the continuous channel having a depth to permanently engage said annular peripheral portion of each lens.

7. A structural arrangement for attaching a lens to a frame of eyewear permitting ventilation, the structural arrangement comprising:
a flexible frame body made of a soft material;
a plurality of retaining members integrally formed together with the flexible frame body; and
the respective retaining members being configured to achieve permanent attachment of the lens to the flexible frame body during formation of the flexible frame body.

8. The structural arrangement as claimed in claim 7 further comprising:
a hollow space defined in the lens; and
a portion of the flexible frame body filled into the hollow space of the lens during formation of the flexible frame body, thereby permanently engaging the lens.

9. The structural arrangement as claimed in claim 8 wherein the retaining members comprise first and second groups thereof, the respective first and second groups of the retaining members abutting opposed sides of the lens and having a plurality of studs extending between the respective first and second groups of the retaining members and crossing the lens through a plurality of holes defined as the hollow space in the lens, the studs being formed integrally with the respective first and second groups of the retaining members during the formation of the flexible frame body.

10. The structural arrangement as claimed in claim 8 wherein the hollow space is defined as a plurality of holes extending through the lens and wherein the portion of the flexible frame body filled into the hollow space is defined as a plurality of studs integrated with the flexible frame body and extending through the respective holes.

11. The structural arrangement as claimed in claim 10 wherein each stud extending from the flexible frame body through one of the holes in the lens, comprises an enlarged end having a size greater than a diameter of the hole in order to permanently engage the lens between the flexible frame body and the enlarged end thereof.

12. The structural arrangement as claimed in claim 8 wherein the hollow space in the lens is defined as a groove formed in the lens at one side thereof, a distance between opposed walls of the groove at an opening thereof being smaller than a distance between the opposed walls at a bottom of the groove such that a projecting member formed together with the flexible frame body during the formation of the flexible frame body, is filled into the groove in the lens to permanently engage the lens to the flexible frame body.

13. The structural arrangement as claimed in claim 7 wherein the retaining members comprise opposed continuous side walls extending into an aperture defined in the flexible frame body which receives the lens, thereby defining a continuous channel therebetween, the continuous channel being configured to correspond to a periphery of the lens for receiving the periphery of the lens therein, and having a depth to permanently engage the lens.

14. The structural arrangement as claimed in claim 13 wherein the flexible frame body comprises a plurality of studs disposed in the continuous channel, each stud extending between the opposed side walls of the channel and crossing the lens through a plurality of holes defined in the lens.

15. The structural arrangement as claimed in claim 7 wherein the flexible frame body is configured to permit air ventilation when the eyewear is in use.
